(19) United States
(12) Patent Application Publication
(10) Pub. No.: US 2009/0299797 A1
(43) Pub. Date: Dec. 3, 2009

(54) INFRASTRUCTURE PLANNING AND DESIGN SERIES ARCHITECTURE EDUCATION FRAMEWORK

(75) Inventors: Michael Kaczmarek, Redmond, WA (US); Fergus Stewart, Redmond, WA (US); Charles Denny, Sammamish, WA (US); Robin Maher, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/130,132

(22) Filed: May 30, 2008

(51) Int. Cl. G05B 19/418

(52) U.S. Cl. 705/8

(57) ABSTRACT

A document is generated that is configured to architect an infrastructure environment. Capabilities and requirements are determined for one or more technology solutions in an infrastructure technology space. Factors considered in selecting the one or more technology solutions for implementation are determined. The determined capabilities and requirements are mapped to the determined factors. A flow diagram is generated based on the mapping. The flow diagram includes a beginning node, at least one of a task node or a decision node, and at least one end node. A description of the flow diagram is generated that includes a description of the task node(s) and/or decision node(s). A document is generated that includes the flow diagram and the description of the flow diagram. The document may be configured to assist a user in selecting an infrastructure technology solution, or to assist the user with planning/designing a selected infrastructure technology solution.

### BACKGROUND

Many businesses today are implementing complex computer-based information systems to meet their information processing, transmitting, storing, and security needs. Such computer-based information systems may include installations of numerous server computers, server applications, networking devices, and networking applications, and may include implementations of a variety of infrastructure technologies. Examples of infrastructure technology spaces include operating systems, virtualization technologies, data security technologies, content management technologies, account management technologies, communications technologies, and many further infrastructure technologies.

Frequently, persons that desire to configure such computer-based information systems with particular infrastructure technologies have to select the infrastructure technology from many solution types for infrastructure technology. After an infrastructure technology solution is selected, planning the design of the selected infrastructure technology solution is a difficult process. Typically, documentation is provided with each infrastructure technology solution that describes how to turn on or off features of the infrastructure technology solution. Such documentation may be very lengthy (e.g., several hundred pages in length). Thus, persons tasked with planning the design of a selected infrastructure technology solution typically do not read all of the information included in the documentation. As a result, a less than optimal design of the selected infrastructure technology solution may occur. For at least these reasons, difficulties exist in selecting and efficiently planning the design of infrastructure technology solutions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A document configured to architect an infrastructure environment is described. In one implementation, the document may be configured to assist the user in selecting an infrastructure technology solution from a plurality of infrastructure technology solutions in an infrastructure technology space. In another implementation, the document may be configured to assist the user with designing an architecture of the selected infrastructure technology solution for the user's application.

In an example implementation, the document includes a flow diagram and a description of the flow diagram. The flow diagram is a schematic representation of an infrastructure technology selection and/or architecture/planning process. The schematic representation provided by the flow diagram contains branches and nodes, including a beginning node, one or more decision nodes and/or task nodes, and one or more end nodes. The flow diagram description is a textual (and optionally graphical) description of the flow diagram. The flow diagram description may include a description section for each decision node and task node present in the flow diagram. Each node description may include a background description related to the corresponding decision node or task node, an options or task description, and a characteristics evaluation.

Methods for generating a document configured to architect an infrastructure environment are described. In accordance with one implementation, capabilities and requirements are determined for one or more technology solutions in an infrastructure technology space. Factors considered in selecting the technology solution(s) for implementation are determined. The determined capabilities and requirements are mapped to the determined factors. A flow diagram is generated based on the mapping. The flow diagram includes a beginning node, at least one of a task node or a decision node, and at least one end node. A description of the flow diagram is generated that includes a description of the task node(s) and/or decision node(s). A document is generated that includes the flow diagram and the description of the flow diagram.

Systems for generating a document configured to architect an infrastructure environment are described. In accordance with one implementation, a system may include a capabilities and requirements determiner, a business factor determiner, a mapper, a flow diagram generator, a flow diagram description generator, and a document generator. The system may utilize manual effort (e.g., human effort) and/or automated techniques (e.g., one or more computers) to perform its functions.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a system for generating and distributing an infrastructure technology architecture document, according to an example embodiment of the present invention.

FIG. 2 shows a block diagram of a user accessing an infrastructure technology architecture document, according to an example embodiment of the present invention.

FIG. 3 shows a block diagram of an infrastructure technology architecture document, according to an example embodiment of the present invention.

FIGS. 4-6 each show an example flow diagram, according to embodiments of the present invention.

FIG. 7 shows a block diagram of a flow diagram description, according to an example embodiment of the present invention.

FIG. 8 shows a block diagram of a node description, according to an example embodiment of the present invention.

FIG. 9 shows a flowchart for generating a document configured to architect a server infrastructure environment, according to an example embodiment of the present invention.

FIG. 10 shows a block diagram of an infrastructure technology architecture document generator, according to an example embodiment of the present invention.

FIG. 11 shows an example decision node, according to an example embodiment of the present invention.

FIG. 12 shows an example task node, according to an example embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Example Embodiments

Frequently, persons that desire to configure infrastructure systems with particular infrastructure technologies have to select the infrastructure technology from several possible solutions. Furthermore, after an infrastructure technology is selected, an architecture for the selected infrastructure technology solution is designed/planned, so that the selected infrastructure technology can eventually be implemented. The design/planning process for selected infrastructure technologies can be difficult. Typically, documentation is provided with an infrastructure technology solution that describes how to turn on or off features of the infrastructure technology solution. Such documentation may be very lengthy (e.g., several hundred pages in length). Thus, persons tasked with designing a selected infrastructure technology solution typically do not read all of the information included in the provided documentation due to time constraints, due to the complexity of the documentation, and/or for further reasons. As a result, the selected infrastructure technology solution may fail to be properly designed, or may be designed in a manner that does not fully take advantage of the capabilities of the selected infrastructure technology. Thus, difficulties exist in selecting and efficiently designing infrastructure technology solutions.

Embodiments of the present invention enable increased efficiency in selecting infrastructure technologies solutions from multiple available solutions. Furthermore, efficient techniques for designing/planning implementations of selected infrastructure technology solutions are provided.

Embodiments for enabling more efficient infrastructure technology selection and planning are described in this section. In embodiments, documents are generated that enable efficient infrastructure technology selection and implementation planning. Such documents may be used by persons tasked with selection of infrastructure technology solutions and/or with the architecting/planning of implementations of infrastructure technology solutions. The example embodiments described herein are provided for illustrative purposes, and are not limiting. Furthermore, additional structural and operational embodiments, including modifications/alterations to described embodiments, will become apparent to persons skilled in the relevant art(s) from the teachings herein.

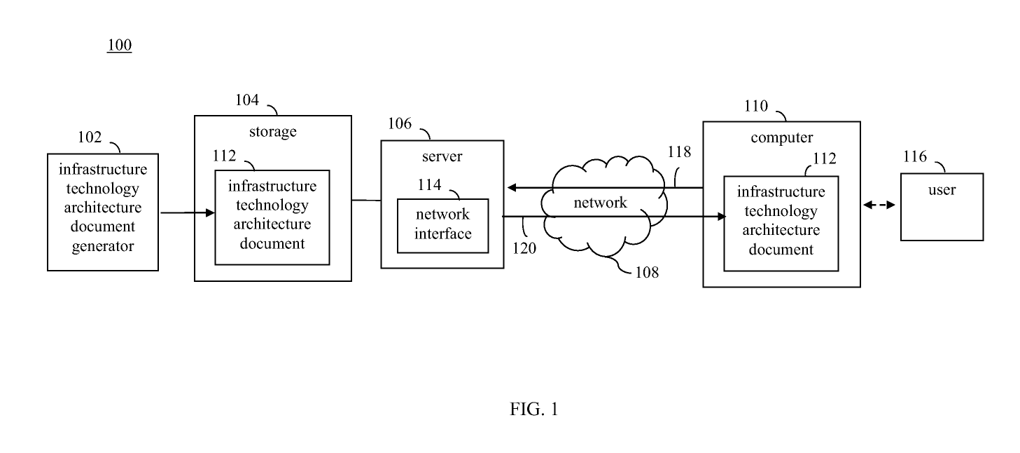

FIG. 1 shows a block diagram of a system 100 for generating and distributing a infrastructure technology architecture document, according to an example embodiment of the present invention. As shown in FIG. 1, system 100 includes an infrastructure technology architecture document generator 102, a storage 104, a server 106, a network 108, and a computer 110. System 100 is described as follows.

Infrastructure technology architecture document generator 102 is configured to generate an infrastructure technology architecture document 112. Infrastructure technology architecture document generator 102 may include the use of human and/or automated effort, and/or may include hardware, software, firmware, or any combination thereof. Example embodiments for infrastructure technology architecture document generator 102 are described in detail further below.

Infrastructure technology architecture document 112 may be a document that may be configured to assist a user (e.g., a user 116 shown in FIG. 1) or users in selecting a type of infrastructure technology. Alternatively or additionally, infrastructure technology architecture document 112 may be a document configured to assist a user (or users) in architecting/planning an implementation of an infrastructure technology. The user may be any person associated with the planning of infrastructure systems, including a high-level infrastructure architect, for example. Such a user may also perform infrastructure technology installation and/or customization, or the installation and/or customization may be performed by one or more further persons. Example embodiments for infrastructure technology architecture document 112 are described in detail further below.

As shown in FIG. 1, infrastructure technology architecture document 112 generated by infrastructure technology architecture document generator 102 is stored in storage 104. Storage 104 may include any type of storage mechanism, including a hard disk drive, an optical disc drive, a memory device such as a RAM device, a ROM device, and/or any other suitable type of storage medium. Server 106 is coupled to storage 104 (e.g., directly or through a network). Server 106 includes a network interface 114. Network interface 114 enables server 106 to communicate over network 108, to enable any number of remote computers, such as computer 110, to access infrastructure technology architecture document 112. Server 106 may be any type of computer server, conventional or otherwise. Network interface 114 may be any type of network interface, wired or wireless, such as an as IEEE 802.11 wireless LAN (WLAN) wireless interface, an Ethernet interface (e.g., a network interface card (NIC)), a USB interface, etc. Network 108 may include a local area network (LAN), a wide area network (WAN), or a combination of networks, such as the Internet.

As shown in FIG. 1, server 106 may receive a request signal 118 through network 108 from computer 110. For example, user 116 may have generated request signal 118 at computer 110. Request signal 118 includes a request for infrastructure technology architecture document 112. In response, server 106 may retrieve infrastructure technology architecture document 112 from storage 104, and may transmit infrastructure technology architecture document 112 to computer 110 through network 108 in a response signal 120. Request signal 118 and response signal 120 may be formatted in any manner, and may be transmitted and received according to any suitable protocol. For example, in an embodiment, request signal 118 may be an email generated by user 116 at computer 110. Response signal 120 may be an email generated at server 106 that is directed to user 116 and attaches infrastructure technology architecture document 112. In another example embodiment, request signal 118 may be an HTTP (hypertext transfer protocol) request, and response signal 120 may be a corresponding response. For instance, user 116 may click on a link of a website provided by server 106, and server 106 may transmit response signal 120 to computer 110 in response to clicking on the link, enabling computer 110 to download infrastructure technology architecture document 112. In further embodiments, request signal 118 and response signal 120 may be formatted and transmitted in alternative ways, as would be known to persons skilled in the relevant art(s).

User 116 may refer to infrastructure technology architecture document 112 for assistance in selecting an infrastructure technology solution and/or for assistance in architecting/planning an infrastructure technology solution. For instance, FIG. 2 shows a block diagram of user 116 accessing infrastructure technology architecture document 112, according to an example embodiment of the present invention. As shown in FIG. 2, user 116 interacts with infrastructure technology architecture document 112. Infrastructure technology architecture document 112 may be available to user 116 in electronic form (e.g., user 116 may view infrastructure technology architecture document 112 at a display of computer 110), or in hardcopy form (e.g., user 116 may have printed infrastructure technology architecture document 112 using a printer device). User 116 may interact with infrastructure technology architecture document 112 by viewing a flow diagram of document 112, by referring to descriptive text in document 112, and/or by accessing other portions of infrastructure technology architecture document 112.

User 116 may select a type of infrastructure technology using infrastructure technology architecture document 112. As shown in FIG. 2, user 116 may access document 112 to generate a selected infrastructure technology solution 208. Furthermore, user 116 may architect/plan an implementation of the infrastructure technology according to infrastructure technology architecture document 112. As shown in FIG. 2, user 116 may access document 112 to generate an infrastructure solution architecture 210. The selected and/or planned infrastructure technology may be implemented by user 116. For example, as shown in FIG. 2, an infrastructure configuration 202 may be implemented based on selected infrastructure technology solution 208 and/or infrastructure solution architecture 210. An implementation of infrastructure configuration 202 may include the installing and/or configuring of one or more servers 204, server applications 206, and/or networking devices 212 (e.g., switches, routers, hubs, etc.) as shown in FIG. 2, depending on the particular infrastructure technology solution of selected infrastructure technology solution 208 and/or the architecture design provided in infrastructure solution architecture 210.

Infrastructure technology architecture document 112 is configured to direct a user through various phases of analysis of an infrastructure technology selection and/or architecture activity, including providing a description of technical options pertaining to one or more infrastructure technology solutions, and providing a review of the technical options against a collection of selection/architecture factors, such as cost, complexity, security, fault tolerance, etc. Document 112 may include questions for the user that further clarify considerations and requirements for the one or more infrastructure technology solutions. This is in contrast to conventionally available documents provided with infrastructure technology solutions which typically provide a laundry list describing every manner in which features may be turned on, off, or otherwise configured.

Document 112 is configured to be more efficient (e.g., shorter) than other available documents that describe how to enable and disable features of infrastructure technology solutions. In this manner, document 112 can provide relatively condensed guidance to user 116 in a form that user 116 can more easily review and act upon. For example, while conventionally available documents that describe how to enable and disable features of infrastructure technology solutions may be hundreds of pages of length, in one example embodiment, document 112 may have a length of approximately fifty pages or less. In other embodiments, however, document 112 can have a length greater than fifty pages, according to the particular application.

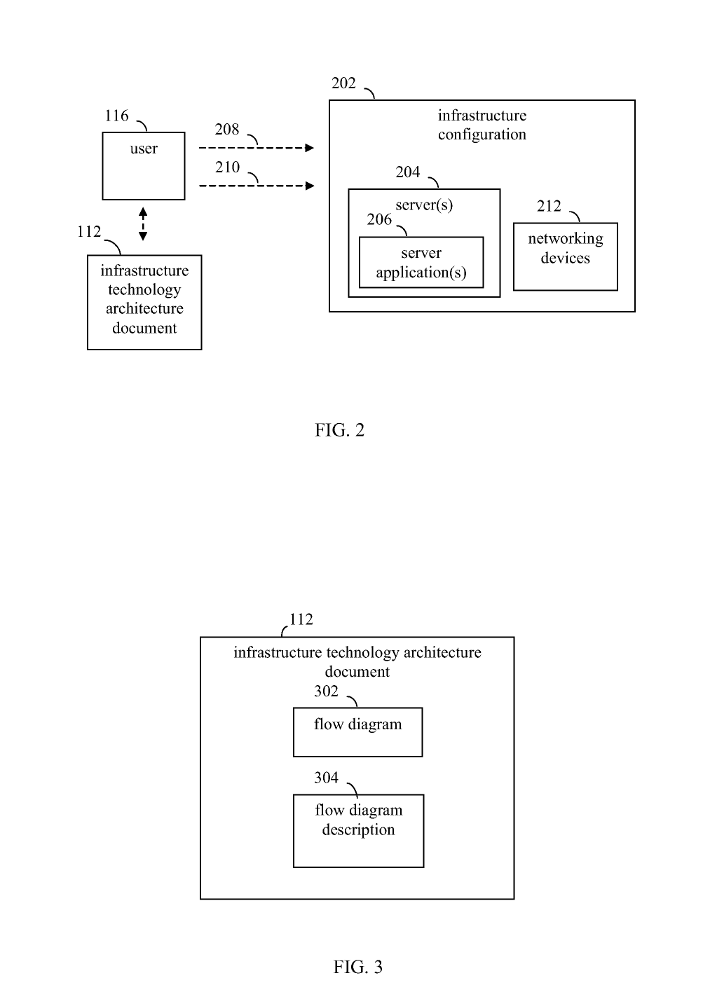

Infrastructure technology architecture document 112 may include a variety of content that is formatted in a variety of ways. For instance, FIG. 3 shows a block diagram of infrastructure technology architecture document 112, according to an example embodiment. As shown in FIG. 3, document 112 includes a flow diagram 302 and a flow diagram description 304. In embodiments, document 112 may include further content, including a title page, an introduction section, an overview of one or more infrastructure technology solutions in an infrastructure technology space, a conclusion section, and/or further types of content. Flow diagram 302 and flow diagram description 304 are described as follows.

Flow diagram 302 is a schematic representation of an infrastructure technology selection and/or architecture/planning process. The schematic representation provided by flow diagram 302 contains nodes and branches. The nodes of flow diagram 302 may include a beginning node, and any number and combination of one or more decision nodes, one or more task nodes, and one or more end nodes. Flow diagram 302 is configured to graphically indicate architectural design decisions and tasks to a user of document 112 for one or more infrastructure technology solutions, some of which may be distilled from one or more documents that provide feature education for the infrastructure technology solutions. The decision nodes and task nodes define important path decisions to be considered during infrastructure technology selection and/or planning/architecture, so that a sufficiently broad perspective of the particular infrastructure technology is considered.

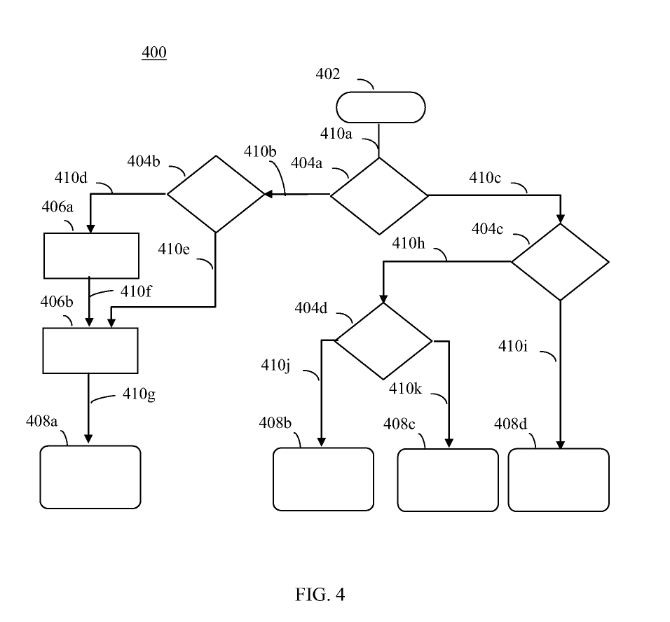

Flow diagram 302 may have various configurations. For instance, FIGS. 4-6 each show an example embodiment of flow diagram 302. The flow diagrams shown in FIGS. 4-6 are provided for purposes of illustration, and are not intended to be limiting. A flow diagram 302 may have any configuration of nodes and branches, depending on the particular application, as would be known to persons skilled in the relevant art(s) from the teachings herein.

FIG. 4 shows a flow diagram 400. Flow diagram 400 includes a beginning node 402, first-fourth decision nodes 404a-404d, first and second task nodes 406a and 406b, first-fourth end nodes 408a-408d, and first-eleventh branches 410a-410k. As shown in FIG. 4, beginning node 402 has an output branch 410a coupled to an input of decision node 404a. Decision node 404a has first and second output branches 410b and 410c. An input of decision node 404b receives output branch 410b. Decision node 404b has output branches 410d and 410e. An input of task node 406a receives output branch 410d. Task node 406a has an output branch 410f. Output branch 410e of decision node 404b is received by task node 406b. An input of task node 406b receives output branches 410e and 410f. Task node 406b has an output branch 410g. Output branch 410g is received by end node 408a.

An input of decision node 404c receives output branch 410c. Decision node 404c has output branches 410h and 410i. An input of decision node 404d receives output branch 410h. Decision node 404d has output branches 410j and 410k. Output branch 410j is received by end node 408b. Output branch 410k is received by end node 408c. Output branch 410i is received by end node 408d.

Each decision node 404 is configured to indicate to a user of document 112 a decision to be made by the user. For example, each decision node 404 may include text that recites a decision between multiple options to be made by the user. Examples of such decision text include “categorize the application as a server application or a client application” or “choose between standalone mode and connected mode.” In FIG. 4, each decision node 404 has a pair of output branches 410. Depending on the choice made by the user, an output branch 410 corresponding to the chosen option is traversed from decision node 404. Note that in an alternative embodiment, a decision node 404 may have more than a pair of output branches 410, including having three output branches 410, four output branches 410, etc.

Each task node 406 is configured to indicate to a user of document 112 a task to be performed by the user. For example, each task node 406 may include text that recites a task to be performed by the user. Examples of such task text include “determine server resource scaling requirements,” “determine server placement,” and “determine bandwidth required between servers.” In FIG. 4, each task node 404 has a corresponding output branch 410 that may be traversed after the task is complete.

A user of document 112 may refer to flow diagram 400, when present, for a process to select and/or architect an infrastructure technology solution, depending on the particular implementation of flow diagram 400. The user of flow diagram 400 begins at beginning node 402. The user traverses through flow diagram 400 by following branch 410a from beginning node 402 to decision node 404a. The user performs the decision set forth by decision node 404a, and follows subsequent encountered branches 410, performing encountered decisions and/or tasks of subsequent decision nodes 404 and task nodes 406. The user finishes traversing flow diagram 400 when one of end nodes 408a-408d is reached.

Thus, in the example of FIG. 4, flow diagram 400 includes both decision nodes 404 and task nodes 406, and includes a plurality of end nodes 408a-408d. Each end node 408 may correspond to a different outcome for the user of flow diagram 400, which may represent a different infrastructure selection and/or plan/architecture. For example, in an embodiment, each of end nodes 408a-408d may correspond to a different infrastructure technology solution in an infrastructure technology space. In such an embodiment, a user that traverses flow diagram 400 to one of end nodes 408a-408d may select the infrastructure technology solution indicated by the reached end node 408. As a result, the user may decide to proceed with pursuing the selected infrastructure technology solution (e.g., as shown in FIG. 2) indicated by the reached end node 408.

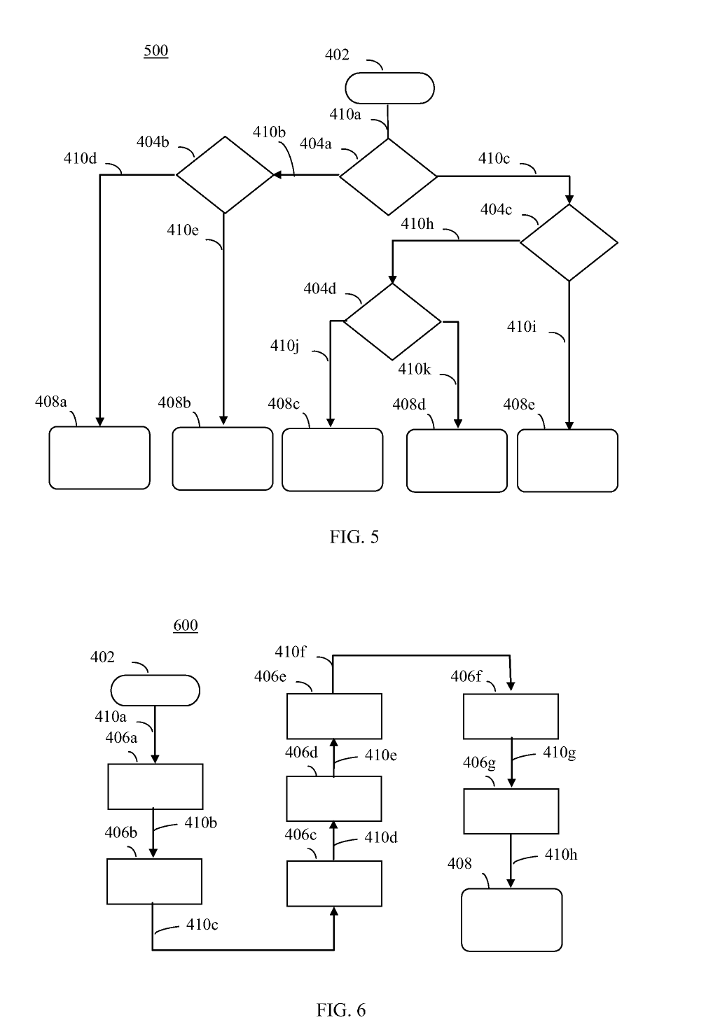

In another embodiment, a flow diagram may include one or more decision nodes 404, but no task nodes 406. For instance, FIG. 5 shows an example flow diagram 500 that includes decision nodes 404, but does not include task nodes 406. As shown in FIG. 5, flow diagram 500 includes beginning node 402, first-fourth decision nodes 404a-404d, first-fifth end nodes 408a-408d, and branches 410a-410e and 410h-410k. As shown in FIG. 5, beginning node 402 has an output branch 410a coupled to an input of decision node 404a. Decision node 404a has first and second output branches 410b and 410c. An input of decision node 404b receives output branch 410b. Decision node 404b has output branches 410d and 410e. Output branch 410d is received by end node 408a. Output branch 410e is received by end node 408b. An input of decision node 404c receives output branch 410c. Decision node 404c has output branches 410h and 410i. An input of decision node 404d receives output branch 410h. Decision node 404d has output branches 410j and 410k. Output branch 410j is received by end node 408c. Output branch 410k is received by end node 408d. Output branch 410i is received by end node 408e.

In another embodiment, a flow diagram may include one or more task nodes 406, but no decision nodes 404. For instance, FIG. 6 shows an example flow diagram 600 that includes task nodes 406, but does not include decision nodes 404. As shown in FIG. 6, flow diagram 600 includes beginning node 402, first-seventh task nodes 406a-406g, end node 408, and branches 410a-410h. First-seventh task nodes 406a-406g are arranged in a serial fashion in FIG. 6. As shown in FIG. 6, beginning node 402 has an output branch 410a coupled to an input of task node 406a. Task node 406a has an output branch 410b that is received by an input of task node 406b. Task node 406b has an output branch 410c that is received by an input of task node 406c. Task node 406c has an output branch 410d that is received by an input of task node 406d. Task node 406d has an output branch 410e that is received by an input of task node 406e. Task node 406e has an output branch 410f that is received by an input of task node 406f. Task node 406f has an output branch 410g that is received by an input of task node 406g. Task node 406g has an output branch 410h that is received by an input of task node 406h. Output branch 410h is received by end node 408.

Thus, in the example of FIG. 6, flow diagram 600 includes a serial arrangement of task nodes 406, and includes a single end node 408. For instance, in an embodiment, end nodes 408 may correspond to an architecture/plan for an infrastructure technology solution that is designed by traversing flow diagram 600, and performing each of task nodes 406a-406g. Task nodes 406a-406h may each be a design task that when all are completed result in a complete infrastructure technology solution plan. As a result, the user may decide to proceed with implementing the infrastructure technology solution according to the determined plan/architecture (e.g., as infrastructure configuration 202 shown in FIG. 2).

Note that in the embodiments of FIGS. 4-6, no feedback branches/paths are present in flow diagrams 400, 500, or 600. In other words, no branches 410 feed backward in flow diagrams 400, 500, or 600 that enable one or more decision nodes 404 or task nodes 406 to be repeated. Such an embodiment with no feedback branches/paths has advantages. In such an embodiment, the flow of decisions indicated by decision nodes 404 and tasks indicated by task nodes 406 is configured that no decisions and/or tasks are repeated, enabling greater efficiency relative to a flow where decisions and/or tasks may be repeated. Flow diagrams 400, 500, 600 are designed to avoid feedback paths in order to provide such efficiency. In this manner, an infrastructure technology selection and/or plan may be completed more efficiently.

Note that in an alternative embodiment, however, one or more feedback paths may be present in a flow diagram, causing one or more decision nodes 404 or task nodes 406 to be repeated at least once.

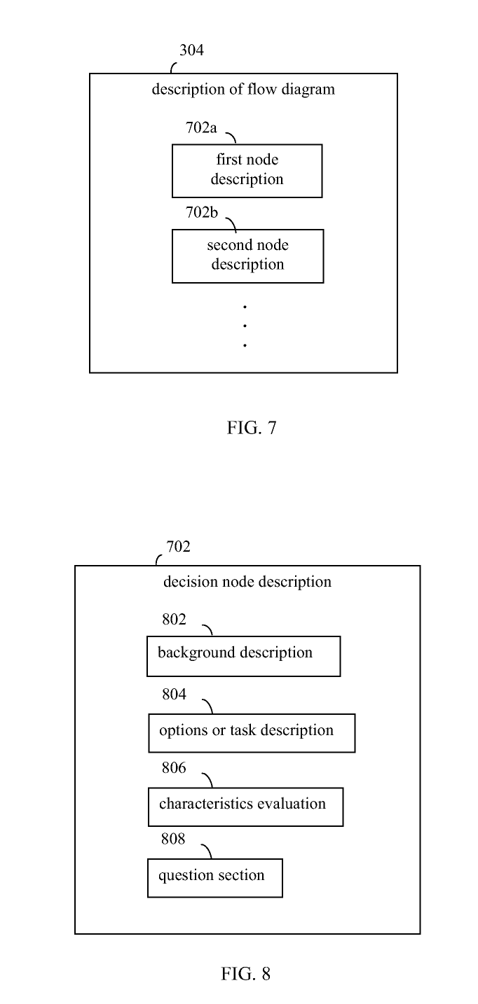

Referring back to FIG. 3, flow diagram description 304 provides a description of flow diagram 302. For example, flow diagram description 304 may provide a textual description of flow diagram 302, and may include one or more supporting diagrams and/or tables in the textual description. In an embodiment, flow diagram description 304 includes a description section for each decision node 404 and task node 406 that are present in the corresponding flow diagram 302. For example, FIG. 7 shows a block diagram of flow diagram description 304, according to an example embodiment. As shown in FIG. 7, flow diagram description 304 includes a first node description 702a, a second node description 702b, and may include further node descriptions 702, depending on a number of decision and task nodes 404 and 406 present in the corresponding flow diagram description 304. Node descriptions 702 are each a description (e.g., textual, graphical, etc.) of a corresponding decision node 404 or task nodes 406. For example, with regard to flow diagram 400 of FIG. 4, first node description 702a may be a description of first decision node 404a shown in FIG. 4, second node description 702b may a description of second decision node 404b, and further node descriptions 702c-702f (not shown in FIG. 7) may be present corresponding to decision nodes 404c and 404d and task nodes 406a and 406b of flow diagram 400.

In an embodiment, node descriptions 702 may be present in flow diagram description 304 in a logical order that is generally consistent with the order in which the corresponding decision nodes 404 and task nodes 406 appear in flow diagram 302. Decision nodes 404 and task nodes 406 may be described by node descriptions 702 in a relatively uniform manner. For instance, FIG. 8 shows a block diagram of a node description 702, according to an example embodiment. As shown in FIG. 8, node description 702 includes a background description 802, an options or task description 804, a characteristics evaluation 806, and a question section 808. Each node description 702 provided in flow diagram description 304 may include one or more of background description 802, options or task description 804, characteristics evaluation 806, and question section 808. Background description 802, options or task description 804, characteristics evaluation 806, and question section 808 are described as follows.

Background description 802 may provide a description of background information, context, and/or general considerations related to one or more infrastructure technology solutions related to the particular decision node 404 or task node 406.

In the context of a decision node 404, options or task description 804 may describe the options available at the decision node 404, which correspond to branches 410 of the decision node 404. For each option, information is provided that may be used by the user to evaluate and select the option. In the context of a task node, options or task description 804 may provide information that may be used by the user to evaluate and perform the task.

Characteristics evaluation 806 describes trade-offs to be evaluated by the user when selecting an option (decision node 404) or performing a task in a particular manner (task node 406). The information provided by characteristics evaluation 806 enables a user to compare options of a decision node 404, including comparing the impact of selecting each option, against characteristics of the infrastructure technology at issue.

Questions section 808 provides one or more questions that may be answered by the user when considering which option to choose (for a decision node 404). Such questions may be directed to determining attributes of the organization (e.g., business) that is selecting/architecting an infrastructure technology solution according to document 112. Such questions may be used to further clarify considerations and requirements related to determining which option to choose.

In an embodiment, characteristics evaluation 806 may include a description/evaluation of one or any combination of the following characteristics. The description/evaluation include an indication of an effect of the characteristic on a decision or task:

Complexity: The complexity characteristic relates the effect a choice made with respect to a decision node 404 or a task performed with respect to a task node 406 can have on overall infrastructure complexity. Complexity may be evaluated with respect to one or more infrastructure technology solutions within a technology space, and may be described in relative terms.

Cost: One or more costs associated with particular options at a decision node 404 or with a task at a task node 406 may be evaluated. The described costs may take into account initial and/or repetitive costs associated with a decision or task with respect to one or more infrastructure technology solutions.

Fault Tolerance: The Fault Tolerance characteristic indicates an effect each option (at a decision node 404) or a task (at a task node 406) may have on the ability of an infrastructure configuration to sustain operation during system failures.

Performance: The performance characteristic may be provided as a rating based on an effect each option (at a decision node 404) or a task (at a task node 406) may have on the performance for one or more infrastructure technologies.

Scalability: The scalability characteristic may be provided to represent an effect each option (at a decision node 404) or task (at a task node 406) may have on an ability of an infrastructure technology to be augmented to achieve higher sustained performance within an infrastructure configuration.

Security: The security characteristic may be provided to represent whether an option (at a decision node 404) or task (at a task node 406) may have a positive or negative impact on overall infrastructure configuration security.

Each of the design options is compared against the above characteristics and is subjectively rated in order to provide a relative weighting of the option against the characteristic. The options are not explicitly rated against each other as there are too many unknowns about the business drivers to accurately compare them.

Each characteristic may be evaluated in a qualitative and/or quantitative, and textual and/or graphical fashion. For example, a textual evaluation may be provided. Alternatively, each characteristic may be evaluated as to its effect on an option according to set of parameters. For instance, the impact of characteristics, such as cost and complexity, may each be expressed on a rating scale, such as being expressed as one of high, medium, or low. Alternatively, the impact of characteristics, such as fault tolerance, performance, scalability, and security, may be represented graphically, such as according to the symbols shown in Table 1 below;

TABLE 1

| Symbol | Definition |
|---|---|
| ↑ | Positive effect on the characteristic. |
| → | No effect on the characteristic or there is |
| | no comparison basis |
| ↓ | Negative effect on the characteristic |

Any other technique may be used in characteristics evaluation 806 to represent the effect of an option or task, as would be known to persons skilled in the relevant art(s).

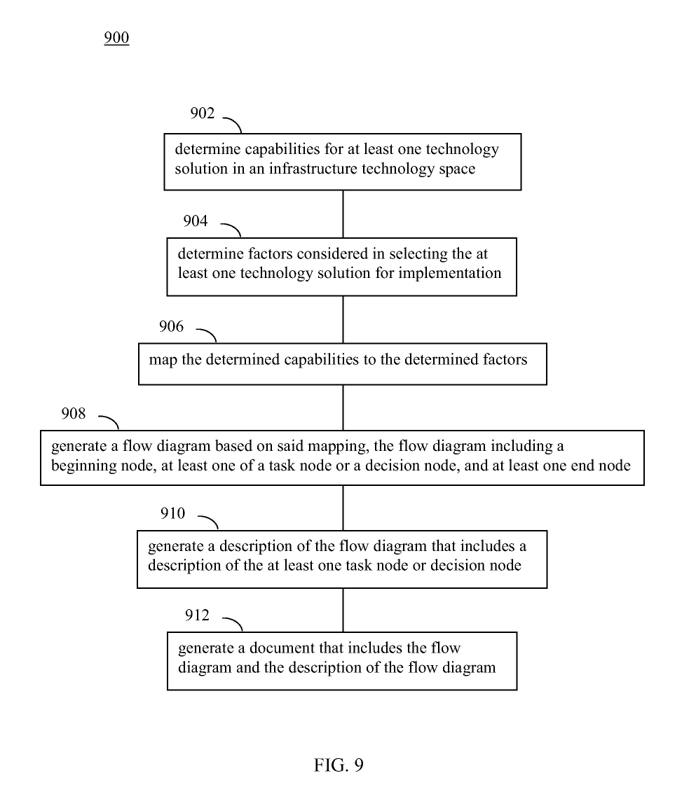

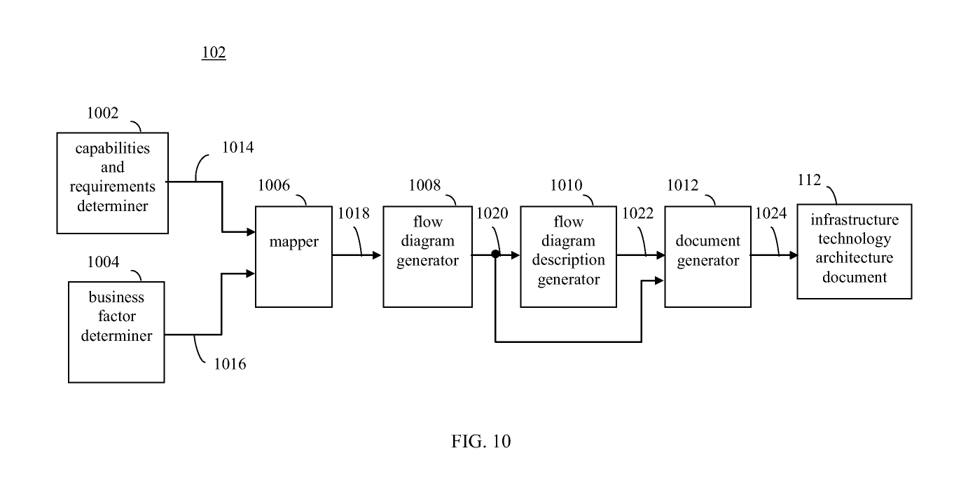

Document 112 may be generated in a variety of ways. For instance, FIG. 9 shows a flowchart 900 for generating a document configured to architect a server infrastructure environment, according to an example embodiment. The document generated by flowchart 900 may be infrastructure technology architecture document 112 shown in FIGS. 1 and 2, for example. For illustrative purposes, FIG. 9 is described with respect to FIG. 10, which shows a block diagram of infrastructure technology architecture document generator 102 of FIG. 1, according to an example embodiment. As shown in FIG. 10, generator 102 includes a capabilities and requirements determiner 1002, a business factor determiner 1004, a mapper 1006, a flow diagram generator 1008, a flow diagram description generator 1010, and a document generator 1012. Other structural and operational embodiments will be apparent to persons skilled in the relevant art(s) based on the discussion regarding flowchart 900. Flowchart 900 is described as follows.

In step 902, capabilities and requirements are determined for at least one technology solution in an infrastructure technology space. For example, capabilities and requirements determiner 1002 shown in FIG. 10 may be configured to determine technical capabilities and requirements for one or more infrastructure technology solutions in an infrastructure technology space. Capabilities and requirements determiner 1002 may be configured to determine these capabilities and requirements in various ways, including in a manual manner and/or an automated (e.g., computerized) manner. As shown in FIG. 10, capabilities and requirements determiner 1002 generates determined capabilities and requirements 1014.

A document 112 is typically directed to a particular infrastructure technology space. Examples of infrastructure technology spaces include operating systems, virtualization technologies, data security technologies, content management technologies, account management technologies, communications technologies, and many further infrastructure technologies. An infrastructure technology space may cover multiple possible infrastructure technology solutions that can be implemented to fulfill an entity's needs for the infrastructure technology space. For example, an entity (e.g., a user, an organization such as a business, etc.) may have a need for virtualization infrastructure technology. In the virtualization technology space, several types of virtualization technology may be available from which to select, including server hardware virtualization, server software virtualization, presentation virtualization, application, virtualization, and desktop virtualization. Various commercially available products may be available as solutions for each infrastructure technology type. Examples of such commercially available products may be Windows Server® 2008 Virtualization, Virtual Server 2005 R2, Windows Server® 2008 Terminal Services, SoftGrid Application Virtualization, Virtual PC, and Windows Vista® Enterprise Centralized Desktop (VECD), each of which is published by Microsoft Corporation of Redmond, Wash.

In an embodiment where document 112 is an infrastructure technology selection document (e.g., a “technology overview” document), document 112 may be configured to enable selection of an infrastructure technology solution that serves the needs of an entity from a plurality of infrastructure technology solutions in an infrastructure technology space. This selection may include selecting a particular commercially available product that enables an infrastructure technology solution.

In another embodiment, where document 112 is an infrastructure technology planning document (e.g., a “technology design” document), document 112 may be directed to a single infrastructure technology solution (e.g., a product that may have already been selected for an entity). In such an embodiment, document 112 may enable the entity to plan/architect an infrastructure technology solution.

In any case (e.g., technology overview document or technology design document), according to step 902, capabilities and requirements are determined for one or more infrastructure technology solutions in the infrastructure technology space to which document 112 is directed. For example, in an embodiment, a person or group of persons (e.g., a research team) may be tasked to determine technology capabilities and requirements for the one or more infrastructure technology solutions. The person(s) may review technology literature (e.g., books, periodicals, articles), including websites, may discuss infrastructure technology solutions with product representatives (e.g., sales persons, technical representatives, etc) of distributors of products in the infrastructure technology solutions covered by document 112, and/or may access any further resources suitable for determining capabilities and requirements for one or more infrastructure technology solutions, as would be known to persons skilled in the relevant art(s).

A variety of types of capabilities and requirements may be determined in step 902 for infrastructure technology solutions. Examples of such capabilities and requirements include resource performance characteristics (e.g., CPU usage, CPU speed, memory, disk capacity, disk access speed, network bandwidth, number of network interface cards (NICs), etc.), fault tolerance characteristics (e.g., host storage and network availability requirements, etc.), scalability characteristics, security characteristics (e.g., backup requirements, etc.), cost requirements, and/or further capabilities and requirements. A number and type of determined capabilities and requirements may depend on the particular infrastructure technology solution(s) at issue.

Referring back to flowchart 900 in FIG. 9, in step 904, factors considered in selecting the at least one technology solution for implementation are determined. For example, business factor determiner 1004 shown in FIG. 10 may be configured to determine factors that may be considered by an entity, such as a user, an organization such as a business, or other entity, in selecting one or more infrastructure technology solutions. In an embodiment where document 112 is to be directed to a plurality of infrastructure technology solutions in an infrastructure technology space, business factor determiner 1004 may be configured to determine factors considered in selecting each of the infrastructure technology solutions. In an embodiment, where document 112 is directed to a single infrastructure technology solution, business factor determiner 1004 may be configured to determine factors considered in selecting the particular infrastructure technology solution. As shown in FIG. 10, business factor determiner 1004 generates determined factors 1016.

Business factor determiner 1004 may be configured to determine these factors in various ways, including in a manual manner and/or an automated manner. For example, in an embodiment, a person or group of persons (e.g., a research team) may survey one or more businesses for factors they may consider in selecting a particular infrastructure technology solution. The person or group of persons may survey business leaders, MBAs, and/or other individuals having suitable business credentials for such factors. The person or group of persons may review business literature (e.g., books, periodicals, articles), technology literature, websites, etc., to determine such factors. The person or group of persons may discuss such factors with product representatives (e.g., sales persons, technical representatives, etc) of distributors of products in the infrastructure technology solutions covered by document 112. The person or persons may access any further resources suitable for determining factors relevant to selection of infrastructure technology solutions, as would be known to persons skilled in the relevant art(s).

A variety of types of factors may be determined in step 904 that relate to selection of infrastructure technology solutions. Examples of factors that may be determined in step 904 may be business factors such as business priorities, business risks, legal/regulatory requirements imposed on technology used by a business, geo-political considerations, budgetary considerations, available hardware/software, business management philosophy/style, business size (e.g., number of employees), number of information technology (IT) professionals available to support an infrastructure technology configuration, a capacity (e.g., space available) of the facilities available to a business, expected growth (or retraction) in the size of a business, a configuration of the business (e.g., size of a sales force, number of computer-enabled office workers, number of programmers, number of offices, average amount of work-related travel undertaken per employee, etc.), the manner(s) in which employees of a business interact with information technology, and further factors. A number and type of such factors that are determined may depend on the particular infrastructure technology solution(s) at issue.

Referring back to flowchart 900 in FIG. 9, in step 906, the determined capabilities and requirements are mapped to the determined factors. For example, mapper 1006 shown in FIG. 10 may be configured to map the capabilities and requirements determined in step 902 to the factors determined in step 904. Mapper 1006 is configured to map the determined capabilities and requirements to the determined factors in order to generate decisions and/or tasks for a user of document 112 to be completed when selecting and/or planning infrastructure technology using document 112. As shown in FIG. 10, mapper 1006 receives determined capabilities and requirements 1014 from capabilities and requirements determiner 1002 and determined factors 1016 from business factor determiner 1004, and generates a map 1018. Map 1018 may have any suitable form, including being in the form of a table or list of decisions and/or tasks.

Mapper 1006 may be configured to perform the mapping in various ways, including in a manual manner and/or an automated manner. For example, in an embodiment, a person or group of persons (e.g., a research team) may analyze the capabilities and requirements determined in step 902 and the factors determined in step 904. The person(s) may perform the mapping based on the analysis. For example, each infrastructure technology solution to be covered by a document 112 may be analyzed for determined capabilities and requirements that relate to determined factors. The determined capabilities and requirements that relate to the determined factors can be grouped, and the groupings may be used to subsequently generate decisions and tasks.

As described above, a document 112 may be configured to aid a user in selecting an infrastructure technology solution of an infrastructure technology space. The person(s) may map capabilities and requirements of one or more infrastructure technology solutions determined in step 902 to business factors determined in step 904 to make various determinations that can be configured as decisions or tasks. For instance, determined capabilities and requirements of a infrastructure technology solutions may be mapped to the determined business factors to indicate conditions in which the infrastructure technology in general may be appropriate or not appropriate for a business, to indicate conditions in which a particular type of infrastructure technology may or may not be appropriate for a business, to indicate a first condition in which a first type of infrastructure technology is better suited for a business relative to a second type of infrastructure technology, and/or a second condition in which the second type of infrastructure technology is better suited for the business relative to the first type. Any suitable type of mapping may be performed that can be used to generate decisions and tasks.

Referring back to flowchart 900 in FIG. 9, in step 908, a flow diagram is generated based on the mapping, the flow diagram including a beginning node, at least one of a task node or a decision node, and at least one end node. For example, flow diagram generator 1008 shown in FIG. 10 may be configured to generate a flow diagram based on the mapping of step 906. As shown in FIG. 10, flow diagram generator 1008 receives map 1018, and generates a flow diagram 1020.

Flow diagram generator 1008 may be configured to generate flow diagram 1020 in various ways, including in a manual manner and/or an automated manner. For example, in an embodiment, flow diagram generator 1008 may include a diagramming software application that enables a user to graphically capture flow diagram 1020. Examples of suitable diagramming software applications include Microsoft Visio® and Microsoft® Word, which are both published by Microsoft Corporation of Redmond, Wash., Corel® WordPerfect®, published by Corel Corporation of Ottawa, Ontario, Canada, and further applications that enable diagramming. In another embodiment, flow diagram generator 1008 may including hardware, software, and/or firmware configured to receive map 1018 (which may be a list of decisions and/or tasks), and to automatically generate flow diagram 1020 based on map 1018.

Flow diagram generator 1008 may generate flow diagram 1020 in any suitable form, as described elsewhere herein or otherwise known. For instance, flow diagrams 400, 500, and 600 shown in FIGS. 4, 5, and 6, respectively, are examples of flow diagram 1020. Flow diagram generator 1008 generates flow diagram 1020 to have a beginning node 402, one or more decision nodes 404 and/or task nodes 406, and one or more end nodes 408.

In an embodiment where document 112 is to be configured to enable a user to select an infrastructure technology solution from a plurality of infrastructure technology solutions, flow diagram generator 1008 may generate flow diagram 1020 to have a plurality end nodes 408, such as shown in FIGS. 4 and 5. Each end node 408 may correspond to a particular infrastructure technology solution that may be selected. Flow diagram 1020 includes decision nodes 404 and/or task nodes 406 that indicate to the user decisions to make and tasks to perform that lead to selection of one of the infrastructure technology solutions.

In an embodiment, where document 112 is to be configured to enable a user to plan a configuration for a particular infrastructure technology solution, flow diagram generator 1008 may generate flow diagram 1020 having a single end node 408, such as shown in FIG. 6. Such a flow diagram 1020 includes task nodes 406 that indicate tasks to perform to the user that lead to completion of an infrastructure technology plan at end node 408.

Flow diagram generator 1008 is configured to generate flow diagram 1020 based on the mapping of step 906. Flow diagram generator 1008 is configured to generate a decision node 404 for flow diagram 1020 to indicate a decision to be made by a user of document 112. Output branches 410 are configured for the decision node 404 that each correspond to a selectable option for the decision node 404. For example, as described above, a mapping may indicate a first condition in which a first type of infrastructure technology is better suited for a business relative to a second type of infrastructure technology, and/or a second condition in which the second type of infrastructure technology is better suited for the business relative to the first type. A decision node 404 may be generated from such a mapping.

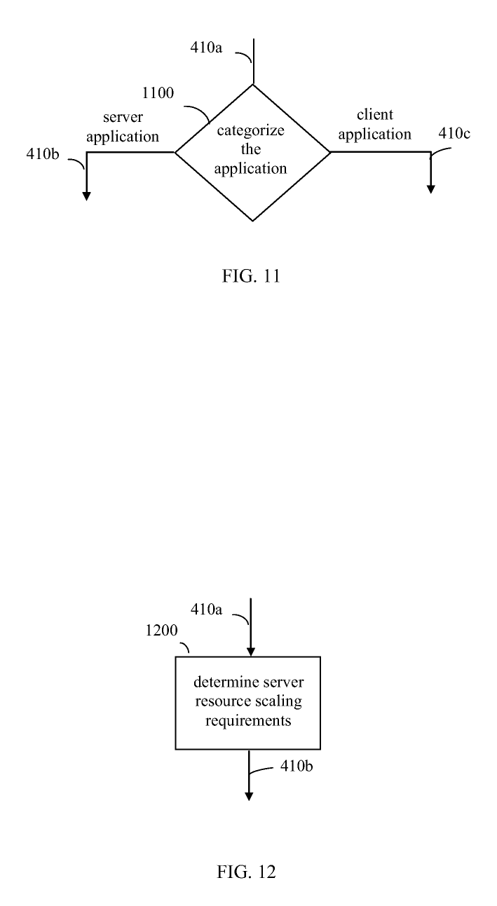

For instance, two types of infrastructure technology solutions may be available that are distinguished by category of application—server applications and client applications. A mapping may indicate business factors in which a server application may be better suited versus a client application, and in which a client application may be better suited versus a server application. A decision node 404 may be generated from such a mapping. For example, FIG. 11 shows an example decision node 1100, according to an example embodiment. As shown in FIG. 11, decision node 1100 is configured to enable a user of document 112 to choose between a server application and a client application. Decision node 1100 is reached (e.g., from another node, not shown in FIG. 11) by branch 410a. Decision node 1100 indicates a choice between a server application and a client application to a user of a document 112. Output branch 410b is traversed by the user if the server application is selected, which may lead to a selection of a first infrastructure technology solution, and output branch 410c is traversed by the user if the client application is selected, which may lead to a selection of a second infrastructure technology solution.

Furthermore, flow diagram generator 1008 may be configured to generate a task node 406 for flow diagram 1020 to indicate a task to be performed by a user of document 112. An output branch 410 may be configured for the task node 404 to be traversed when the task is complete.

For example, map 1018 may indicate that server resource scaling requirements need to be determined. A task node 406 may be generated from such a mapping. For example, FIG. 12 shows an example task node 1200, according to an example embodiment. As shown in FIG. 12, task node 1200 is configured to indicate to a user of document 112 a task to determine server resource scaling requirements. Task node 1200 is reached (e.g., from another node, not shown in FIG. 12) by branch 410a. Task node 1200 indicates the task of determining server resource scaling requirements to a user of a document 112. Output branch 410b is traversed by the user after completion of the task.

Any type and number of decisions nodes 402 and/or task nodes 406 may be generated by flow diagram generator 1008 from map 1018 similarly to decision node 1100 and task node 1200, as would be known to persons skilled in the relevant art(s) from the teachings herein.

Referring back to flowchart 900 in FIG. 9, in step 910, a description of the flow diagram is generated that includes a description of the at least one task node or decision node. For example, flow diagram description generator 1010 shown in FIG. 10 may be configured to generate a description of the flow diagram generated in step 908. As shown in FIG. 10, flow diagram description generator 1010 receives flow diagram 1020, and generates flow diagram description 1022.

Flow diagram description generator 1010 may be configured to generate the flow diagram description in various ways, including in a manual manner and/or an automated manner. For example, in an embodiment, flow diagram description generator 1010 may include a word processing application that enables a user to textually and/or graphically describe flow diagram 1020. Examples of suitable word processing applications include Microsoft® Word, Corel® WordPerfect®, and further word processing applications. Flow diagram description generator 1010 may generate the flow diagram description in any suitable form, as described elsewhere herein or otherwise known. For instance, flow diagram description generator 1010 may be configured to generate flow diagram description 1022 in the form of flow diagram description 304 shown in FIG. 3 and described above. For example, flow diagram description generator 1010 may be configured to describe a description of each decision node and task node in similar manner as described above for node descriptions 702 shown in FIG. 7.

Referring back to flowchart 900 in FIG. 9, in step 912, a document is generated that includes the flow diagram and the description of the flow diagram. For example, document generator 1010 shown in FIG. 10 may be configured to generate a document that includes the flow diagram generated in step 908 and the flow diagram description generated in step 910. As shown in FIG. 10, document generator 1010 receives flow diagram 1020 and flow diagram description 1022, and generates infrastructure technology architecture document 112.

Document generator 1012 may be configured to generate document 112 in various ways, including in a manual manner and/or an automated manner. For example, in an embodiment, document generator 1012 may include a word processing application that enables a user to combine flow diagram 1020 and flow diagram description 1022 into document 112. In an embodiment, document generator 1012 may include a same word processing application as flow diagram description generator 1010. For example, document generator 1012 may incorporate flow diagram 1020 into a document that includes flow diagram description 1022. Examples of suitable word processing applications include Microsoft® Word, Corel® WordPerfect®, and further word processing applications. Document generator 1012 may generate document 112 in any suitable form. Furthermore, document generator 1012 may include storage configured to store document 112 in electronic form, and/or a printing device configured to print document 112 in hardcopy form.

Note that any one or more of capabilities and requirements determiner 1002, business factor determiner 1004, mapper 1006, flow diagram generator 1008, flow diagram description generator 1010, and document generator 1012 shown in FIG. 10 may include hardware, software, firmware, or any combination thereof to perform at least a portion of their functions. For example, any one or more of capabilities and requirements determiner 1002, business factor determiner 1004, mapper 1006, flow diagram generator 1008, flow diagram description generator 1010, and document generator 1012 may include computer code configured to be executed in one or more processors. Alternatively, any one or more of capabilities and requirements determiner 1002, business factor determiner 1004, mapper 1006, flow diagram generator 1008, flow diagram description generator 1010, and document generator 1012 may include hardware logic/electrical circuitry.

In an embodiment, capabilities and requirements determiner 1002, business factor determiner 1004, mapper 1006, flow diagram generator 1008, flow diagram description generator 1010, and/or document generator 1012 may be partially or entirely implemented in one or more computers, including a personal computer, a mobile computer (e.g., a laptop computer, a notebook computer, a handheld computer such as a personal digital assistant (PDA) or a Palm™ device, etc.), or a workstation. These example devices are provided herein purposes of illustration, and are not intended to be limiting. Embodiments of the present invention may be implemented in further types of devices, as would be known to persons skilled in the relevant art(s).

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include logic for implementing capabilities and requirements determiner 1002, business factor determiner 1004, mapper 1006, flow diagram generator 1008, flow diagram description generator 1010, document generator 1012, flowchart 900, and/or further embodiments of the present invention described herein. Embodiments of the invention are directed to computer program products comprising such logic (e.g., in the form of software) stored on any computer useable medium. Such software, when executed in one or more data processing devices, causes a device to operate as described herein.

### Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for generating a document configured to architect a server infrastructure environment, comprising:
determining capabilities and requirements for at least one technology solution in an infrastructure technology space;
determining factors considered in selecting the at least one technology solution for implementation;
mapping the determined capabilities and requirements to the determined factors;
generating a flow diagram based on said mapping, the flow diagram including a beginning node, at least one of a task node or a decision node, and at least one end node, the flow diagram including no feedback paths;
generating a description of the flow diagram that includes a description of the at least one task node or decision node; and
generating a document that includes the flow diagram and the description of the flow diagram.

2. The method of claim 1, wherein said determining capabilities and requirements for at least one technology solution in an infrastructure technology space comprises:
determining capabilities and requirements for at least one technology solution in one of an operating system space, a virtualization technology space, data security technology space, a content management technology space, an account management technology space, or a communications technology space.

3. The method of claim 1, wherein said determining factors considered in selecting the at least one technology solution for implementation comprises:
determining at least one of a cost related to a first technology solution, a complexity of the first technology solution relative to at least one other technology solution, a fault tolerance of the first technology solution, a performance characteristic of the first technology solution, a scalability of the first technology solution, or a security aspect of the first technology solution.

4. The method of claim 1, wherein said mapping the determined capabilities and requirements to the determined factors comprises:
generating a list that includes at least one decision or task.

5. The method of claim 1, wherein said generating a flow diagram based on said mapping comprises:
generating the flow diagram based on said mapping, the flow diagram including a beginning node, at least one of a task node or a decision node, and a plurality of end nodes, the plurality of end nodes corresponding to the plurality of technology solutions.

6. The method of claim 5, wherein said generating a document that includes the flow diagram and the description of the flow diagram comprises:
generating an infrastructure technology overview document configured to assist a user with selection of an infrastructure technology solution.

7. The method of claim 1, wherein the flow diagram includes no decision nodes, wherein said generating a flow diagram based on said mapping comprises:
generating the flow diagram based on said mapping, the flow diagram including a beginning node, at least one task node, and at least one end node.

8. The method of claim 7, wherein said generating a document that includes the flow diagram and the description of the flow diagram comprises:
generating an infrastructure technology design document configured to assist a user with planning an infrastructure technology solution.

9. The method of claim 1, wherein said generating a flow diagram based on said mapping comprises:
configuring a decision node of the flow diagram to represent a choice that distinguishes between at least a pair of the technology solutions, the decision node having a plurality of output branches, each output branch corresponding to at least one technology solution.

10. The method of claim 9, wherein said configuring a decision node comprises:
basing the choice on at least one of the determined capabilities and requirements for the at least one technology solution in an infrastructure technology space or the determined factors considered in selecting the at least one technology solution for implementation.

11. The method of claim 1, wherein said generating a flow diagram based on said mapping comprises:
configuring a task node of the flow diagram to represent a design task corresponding to at least one of the determined capabilities and requirements.

12. The method of claim 1, wherein said generating a flow diagram based on said mapping comprises:
graphically capturing the flow diagram using a diagramming software application.

13. The method of claim 1, wherein said generating a description of the flow diagram that includes a description of the at least one task node or decision node comprises:
describing each of a plurality of options available at a first decision node.

14. The method of claim 1, wherein said generating a description of the flow diagram that includes a description of the at least one task node or decision node comprises:
describing a task to be performed to complete a first task node.

15. The method of claim 1, further comprising:
storing the document; and
enabling the stored document to be accessed over a network.

16. A method for generating a document configured to architect a server infrastructure environment, comprising:
determining capabilities and requirements for at least one technology solution in an infrastructure technology space;
determining factors considered in selecting the at least one technology solution for implementation;
generating a flow diagram based on the determined capabilities and requirements and the determined factors, the flow diagram including a beginning node, at least one of a task node or a decision node, and at least one end node, the flow diagram including no feedback paths;
generating a description of the flow diagram that includes a description of the at least one task node or decision node; and
generating a document that includes the flow diagram and the description of the flow diagram.
